(19) United States
(12) Patent Application Publication
(10) Pub. No.: US 2014/0122127 A1
(43) Pub. Date: May 1, 2014

(54) ADMINISTERING A PRESCRIPTION AND TREATMENT REGIMEN

(71) Applicant: Complete Consent, LLC, Savannah, GA (US)

(72) Inventor: Sidney P. Smith, Savannah, GA (US)

(73) Assignee: Complete Consent, LLC, Savannah, GA (US)

(21) Appl. No.: 14/069,872

(22) Filed: Nov. 1, 2013

Related U.S. Application Data
(60) Provisional application No. 61/796,045, filed on Nov. 1, 2012.

(51) Int. Cl. G06F 19/00

(52) U.S. Cl. CPC G06F 19/3481
USPC 705/3

(57) ABSTRACT

A system and method for administering a prescription and treatment regimen for a patient utilizes a computer including a processor, a memory, a display, a network interface, and a user interface. After inputting a diagnosis, patient data and peripheral data are accessed. Based on this data, the treatment regimen is identified and displayed for the diagnosis based on the patient data and the peripheral data. The treatment is varied depending on the patient data and the peripheral data.

### CROSS-REFERENCES TO RELATED APPLICATIONS

This application claims the benefit of U.S. Provisional Patent Application Ser. No. 61/796,045, filed Nov. 1, 2012, the entire content of which is herein incorporated by reference.

### STATEMENT REGARDING FEDERALLY SPONSORED RESEARCH OR DEVELOPMENT

(NOT APPLICABLE)

### BACKGROUND OF THE INVENTION

The invention relates to a system and method of administering a prescription and treatment regimen for a patient and, more particularly, to administering a prescription and treatment regimen for a patient that utilizes patient data and peripheral data to define a treatment regimen beyond prescription medication.

Prescription drug use in the United States has been rising steadily in the past decade, and the current trend shows no signs of slowing, according to the CDC. Simply writing a prescription with no education or patient interaction results in less effective care for a patient. That is, treatment with prescription medication can be enhanced when combined with patient interaction, patient activity and participation, and patient education. Other factors may also be helpful to make prescription medication more effective.

### BRIEF SUMMARY OF THE INVENTION

It would be desirable to provide a system and methodology for administering a prescription and treatment regimen for a patient that incorporates patient data and peripheral data to increase the effectiveness of prescription medication. It would be desirable for the information including the treatment regimen to be available to the care provider based on a patient diagnosis.

By way of example, a leg infection may get better with a prescription, but the patient may see more effective improvement if a handout or education is provided to the patient that recommends raising the leg, applying a warm compress, using bleach baths, and placing a prescription in the nose. In another example, a patient with a slipped disc can improve with or without a prescription pain reliever, but full recovery can be provided with educational videos including handouts, as well as referrals to a physical trainer, an occupational therapist, acupuncture, and recommendations for vitamin supplements. The system provides for holistic treatments in addition to prescription medication. The treatment regimen is uniquely created each time a patient presents based on patient data, evidence based treatments from the FDA, medical societies, and physician experience, medical literature, and patient data changes over time.

In an exemplary embodiment, a method of administering a prescription and treatment regimen for a patient utilizes a computer including a processor, a memory, a display, a network interface, and a user interface. The method includes the steps of (a) inputting a diagnosis with the user interface; (b) the processor accessing patient data either stored in the memory or stored remotely and accessible by the network interface; (c) the processor accessing peripheral data relating to the diagnosis; and (d) the processor identifying and displaying the treatment regimen for the diagnosis based on the patient data and the peripheral data by accessing a database either stored in the memory or stored remotely and accessible by the network interface, wherein the treatment is varied depending on the patient data and the peripheral data.

Step (d) may be practiced by organizing the treatment regimen into initial therapy, alternative therapy and ancillary therapy.

Step (c) may be practiced by accessing peripheral data including at least one of FDA guidelines, medical literature, physician experience, local trends and community data.

Step (b) may be practiced by accessing patient data including at least one of allergies, age, medical history, location of problem, race, distance from clinic, travel capabilities, family history, symptoms, vital signs, disease progression, and patient prior response to treatment.

Step (d) may be practiced by identifying and displaying the treatment regimen including the prescription and complementary procedures or actions to be performed by the patient. In this context, step (d) may be further practiced by displaying an educational video or identifying a link to the educational video.

Still further, step (d) may be practiced by identifying and displaying phases of the treatment regimen including a first line phase, a second line phase, and a third line phase. The first line phase presents the treatment regimen based on cost and availability of the treatment to the patient, evidence based medical preferences, and low treatment risks. The second line phase presents the treatment regimen based on the patient data combined with patient response to the first line phase treatment if the first line phase treatment was ineffective. The third line phase presents the treatment regimen based on the patient data combined with the patient response to the second line phase treatment if the second line phase treatment was ineffective, and higher risk and experimental treatments.

The peripheral data may include a need for a referral to another provider, and step (d) may be practiced by identifying and displaying the treatment regimen including the referral to another provider.

Step (d) may be practiced by identifying and displaying a favorites treatment regimen specific to a user practitioner.

In one arrangement, step (d) may be practiced by dividing the display into three sections including a My Favorites section, a Branded Products section, and a System Average Treatments section. The My Favorites section lists commonly used treatment regimens for treating the diagnosis. The Branded Products section lists one of branded products, available services, and paid advertisements. The System Average Treatments section includes an average use of the treatment regimen for the diagnosis. In this context, the method may further include the step of enabling a user practitioner to move treatment regimens and components of treatment regimens into and out of the My Favorites section. Additionally or alternatively, with the network interface, the method may include enabling a user practitioner to access a library of prescriptions, vitamins, herbs and procedures relevant to the diagnosis.

Where the treatment regimen comprises a prescription, the method may further include (e) the processor sending the prescription to a clearing house pharmacy.

In another exemplary embodiment, a non-transitory computer readable medium stores computer instructions that, when executed by computer, cause the computer to perform the method of administering a prescription and treatment regimen for a patient.

In yet another exemplary embodiment, a system for administering a prescription and treatment regimen for a patient includes a computer with a processor, a memory, a display, a network interface, and a user interface. The user interface is accessed to input a diagnosis. A first database stores patient data, where the processor is programmed to access the patient data through the memory or remotely by the network interface. A second database stores peripheral data relating to the diagnosis, where the processor is programmed to access the peripheral data. The processor is further programmed to identify and display the treatment regimen for the diagnosis based on the patient data and the peripheral data by accessing a third database either stored in the memory or stored remotely and accessible by the network interface. The treatment is varied depending on the patient data and the peripheral data.

### BRIEF DESCRIPTION OF THE DRAWINGS

These and other aspects and advantages will be described in detail with reference to the accompanying drawings, in which:

FIG. 1 is a schematic block diagram of an exemplary computer system;

FIG. 2 is an exemplary screen shot showing administering a prescription and treatment regimen for a patient; and

FIG. 3 is a flow chart showing prescription processing via a clearing house pharmacy.

### DETAILED DESCRIPTION OF THE INVENTION

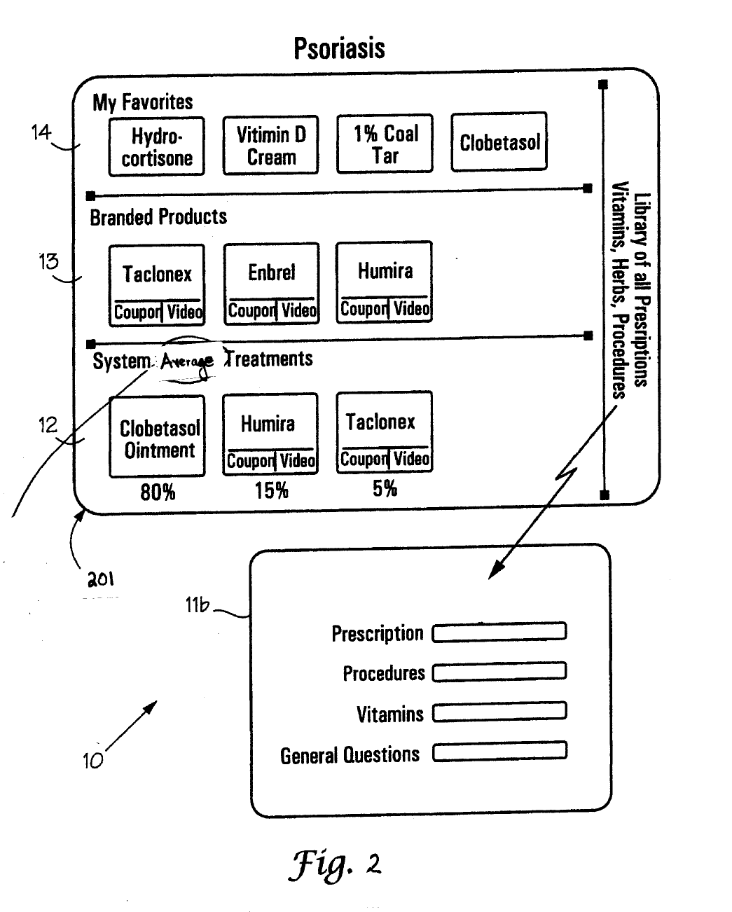

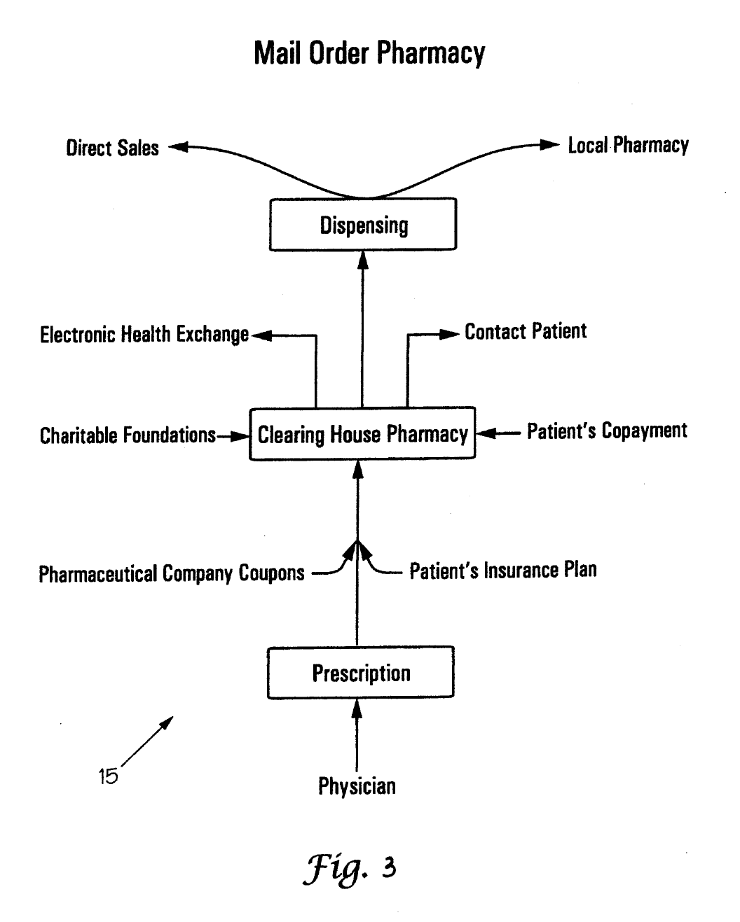

The prescription and treatment regimen system described with reference to FIGS. 2-3 is preferably a browser-based system in which a program running on a user's computer (the user's web browser) requests information from a server program running on a system server. The system server sends the requested data back to the browser program, and the browser program then interprets and displays the data on the user's computer screen. The process is as follows:

1. The user runs a web browser program on his/her computer.

2. The user connects to the server computer (e.g., via the Internet). Connection to the server computer may be conditioned upon the correct entry of a password as is well known.

3. The user requests a page from the server computer. The user's browser sends a message to the server computer that includes the following:
the transfer protocol (e.g., http://); and
the address, or Uniform Resource Locator (URL).

4. The server computer receives the user's request and retrieves the requested page, which is composed, for example, in HTML (Hypertext Markup Language).

5. The server then transmits the requested page to the user's computer.

6. The user's browser program receives the HTML text and displays its interpretation of the requested page.

Thus, the browser program on the user's computer sends requests and receives the data needed to display the HTML page on the user's computer screen. This includes the HTML file itself plus any graphic, sound and/or video files mentioned in it. Once the data is retrieved, the browser formats the data and displays the data on the user's computer screen. Helper applications, plug-ins, and enhancements such as Java™ enable the browser, among other things, to play sound and/or display video inserted in the HTML file. The fonts installed on the user's computer and the display preferences in the browser used by the user determine how the text is formatted.

If the user has requested an action that requires running a program (e.g., a search), the server loads and runs the program. This process usually creates a custom HTML page “on the fly” that contains the results of the program's action (e.g., the search results), and then sends those results back to the browser.

Browser programs suitable for use in connection with the account management system of the present invention include Mozilla Firefox® Mozilla and Internet Explorer available from Microsoft® Corp.

While the above description contemplates that each user has a computer running a web browser, it will be appreciated that more than one user could use a particular computer terminal or that a “kiosk” at a central location (e.g., a cafeteria, a break area, etc.) with access to the system server could be provided.

It will be recognized by those in the art that various tools are readily available to create web pages for accessing data stored on a server and that such tools may be used to develop and implement the system described below and illustrated in the accompanying drawings.

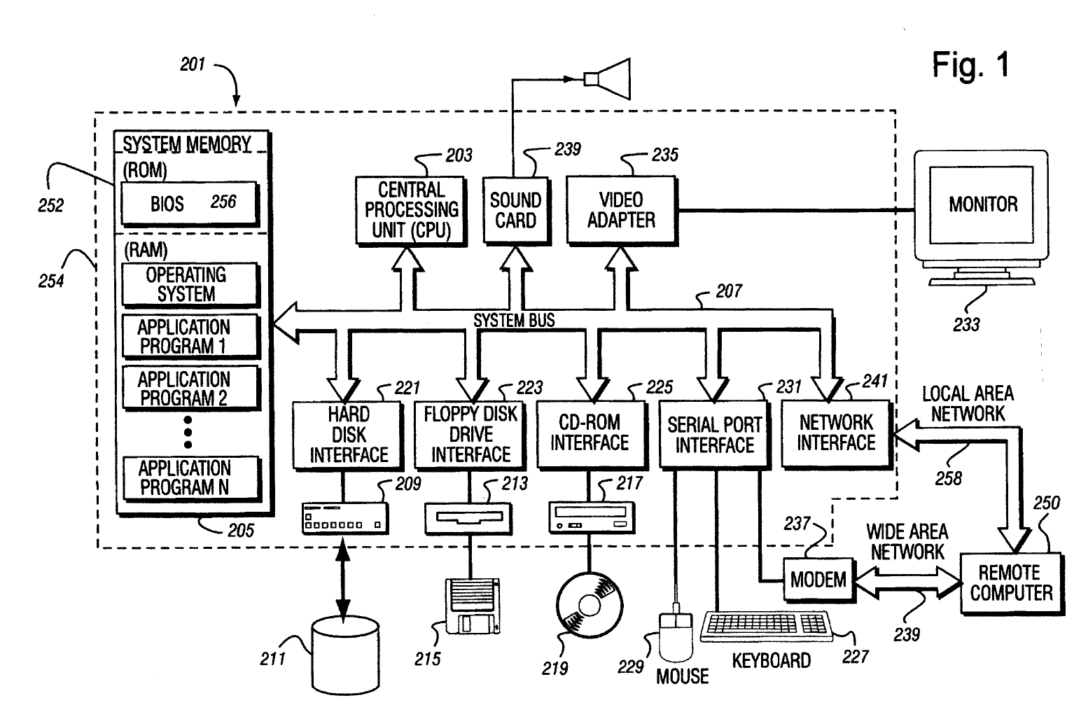

FIG. 1 generally illustrates a computer system 201 suitable for use as the client and server components of the described system. It will be appreciated that the client and server computers will run appropriate software and that the client and server computers may be somewhat differently configured with respect to the processing power of their respective processors and with respect to the amount of memory used. Computer system 201 includes a processing unit 203 and a system memory 205. A system bus 207 couples various system components including system memory 205 to processing unit 203. System bus 207 may be any of several types of bus structures including a memory bus or memory controller, a peripheral bus, and a local bus using any of a variety of bus architectures. System memory 205 includes read only memory (ROM) 252 and random access memory (RAM) 254. A basic input/output system (BIOS) 256, containing the basic routines that help to transfer information between elements within computer system 201, such as during start-up, is stored in ROM 252. Computer system 201 further includes various drives and associated computer-readable media. A hard disk drive 209 reads from and writes to a (typically fixed) magnetic hard disk 211; a magnetic disk drive 213 reads from and writes to a removable “floppy” or other magnetic disk 215; and an optical disk drive 217 reads from and, in some configurations, writes to a removable optical disk 219 such as a CD ROM or other optical media. Hard disk drive 209, magnetic disk drive 213, and optical disk drive 217 are connected to system bus 207 by a hard disk drive interface 221, a magnetic disk drive interface 223, and an optical drive interface 225, respectively. The drives and their associated computer-readable media provide nonvolatile storage of computer-readable instructions, SQL-based procedures, data structures, program modules, and other data for computer system 201. In other configurations, other types of computer-readable media that can store data that is accessible by a computer (e.g., magnetic cassettes, flash memory cards, digital video disks, Bernoulli cartridges, random access memories (RAMs), read only memories (ROMs) and the like) may also be used.

A number of program modules may be stored on the hard disk 211, removable magnetic disk 215, optical disk 219 and/or ROM 252 and/or RAM 254 of the system memory 205. Such program modules may include an operating system providing graphics and sound APIs, one or more application programs, other program modules, and program data. A user may enter commands and information into computer system 201 through input devices such as a keyboard 227 and a pointing device 229. Other input devices may include a microphone, joystick, game controller, satellite dish, scanner, or the like. These and other input devices are often connected to the processing unit 203 through a serial port interface 231 that is coupled to the system bus 207, but may be connected by other interfaces, such as a parallel port interface or a universal serial bus (USB). A monitor 233 or other type of display device is also connected to system bus 207 via an interface, such as a video adapter 235.

The computer system 201 may also include a modem or broadband or wireless adapter 237 or other means for establishing communications over the wide area network 239, such as the Internet. The modem 237, which may be internal or external, is connected to the system bus 207 via the serial port interface 231. A network interface 241 may also be provided for allowing the computer system 201 to communicate with a remote computing device 250 via a local area network 258 (or such communication may be via the wide area network 239 or other communications path such as dial-up or other communications means). The computer system 201 will typically include other peripheral output devices, such as printers and other standard peripheral devices.

As will be understood by those familiar with web-based forms and screens, users may make menu selections by pointing-and-clicking using a mouse, trackball or other pointing device, or by using the TAB and ENTER keys on a keyboard. For example, menu selections may be highlighted by positioning the cursor on the selections using a mouse or by using the TAB key. The mouse may be left-clicked to select the selection or the ENTER key may be pressed. Other selection mechanisms including voice-recognition systems, touch-sensitive screens, etc. may be used, and the invention is not limited in this respect.

The system method and architecture will be described with reference to FIGS. 2 and 3.

FIG. 2 is an exemplary screen shot showing the system and methodology for administering a prescription and treatment regimen for a patient. The system enables a care provider to prescribe medication after a diagnosis is rendered. The term “diagnosis” as used herein refers to any condition or ailment for which medication may be prescribed and/or a treatment regimen may be recommended. The “diagnosis” includes currently diagnosed and previously diagnosed disease process.

In the exemplary screen shot of FIG. 2, psoriasis is entered as the diagnosis into a computing device 201. Entry of the diagnosis signals the computing device to recall the treatment regimen and display the treatment regimen on the screen of the computing device. In the exemplary embodiment, the screen is divided into three sections, including a My Favorites section 14, Branded Products 13, and System Average Treatments 12.

The My Favorites section 14 contains one or more icons denoting commonly used medicines in treating the selected diagnosis. The middle section of the computing device's screen is the Branded Products section 13. This section contains branded products, services that are available and/or paid advertisements. The bottom third of the computing device screen is the System Average Treatments section 12, which contains the average use of the treatment of the diagnosis rendered. A tool bar 10 may, if desired, be incorporated into the system to enable a care provider to mix and match areas from My Favorites 14, Brand Products 13 and the System Average Treatments 12 between each of the categories so that if the care provider desires to modify My Favorites 14, he can simply move a new treatment into that area. Further, the tool bar 10 has access to a library of all prescriptions, vitamins, herbs and procedures that can be displayed via a pull down menu 11b. The pull down menu 11b is an entry point for the care provider to receive information about the library, and the care provider may, if desired, use the information gathered to add to his My Favorites 14.

In the method of administering the prescription and treatment regimen for a patient, after inputting the diagnosis with a user interface, the processor accesses patient data either stored in the memory or stored remotely and accessible by the network interface. The processor also accesses peripheral data relating to the diagnosis. With this information, the processor identifies and displays the treatment regimen for the diagnosis based on the patient data and the peripheral data by accessing a database either stored in the memory or stored remotely and accessible by the network interface. Based on variable patient data and peripheral data, the treatment is varied depending on the accessed data.

Thus, the presented option for the prescription and treatment regimen will be changed and organized based on numerous data. For example, the peripheral data may include, without limitation, FDA guidelines, medical literature, physician experience, local trends and/or community data. Patient data may include, without limitation, allergies, age, medical history, location of problem, race, distance from clinic, travel capabilities, family history, symptoms, vital signs, disease progression, and/or patient prior response to treatments.

As noted, through data collection, the favorite treatments are preferably organized into initial therapy, alternative therapy, and ancillary therapy, which is collectively called the first line phase. The focus of the first line/initial phase relates to patient data, cost concerns, availability to patient, evidence based information (e.g., double blind study clinical trials), little risk of treatment, few side effects and more physician experience with treatment.

A second line phase may be applicable when the first line phase treatment is ineffective. The second line phase presents the treatment regimen based on the patient data combined with patient response to the first line phase treatment over time. The second line phase is typically applicable when the first line phase did not work. This treatment regimen may be less available to the patient and more costly, but may have better results. The second line phase treatment regimen should include recommendations and prescriptions based on clinical trials with small groups (at least). Typically, the second line phase prescriptions and treatment regimens may subject the patients to more risk with treatment including more side effects and less caregiver experience.

A third line phase presents the treatment regimen based on the patient data combined with the patient response to the second line phase treatment if the second line phase treatment was ineffective. The third line phase treatment regimen is applicable when neither the first line phase treatment nor the second line phase treatment has been effective. The treatment regimen and/or prescription medication may include experimental or anecdotal components (which may have been subjected to few studies if any). In addition to little or no physician experience, the prescriptions and treatment regimens typically subject the patients to higher risks and additional side effects.

Generally, the process of identifying and displaying the treatment regimen for the diagnosis includes a prescription and complementary procedures or actions to be performed by the patient. For example, although a leg infection may get better with prescription medication, the patient may have more effective treatment if information is provided regarding raising the leg, applying a warm compress, using bleach baths, and placing a prescription medication in the nose. The system may thus display an educational video or otherwise identify a link to the educational video. In another example, if a patient has a slipped disc or the like, prescription medication may be used to control pain but may be less effective to provide for healing. Educational videos and/or handouts may include exercises and the like to facilitate recovery. The system may also identify a need for referrals to a physical trainer, to an occupational therapist, or for acupuncture. Additionally, the system may identify vitamin supplements (e.g., Chondroitin Sulfate for a slipped disc) to facilitate healing and recovery.

An important feature of the system and methodology of the preferred embodiments is that the prescription and treatment regimen system may incorporate holistic treatments in addition to prescription medication in a single platform. The treatment regimen is uniquely created each time a patient presents based on patient data, evidence based treatments from the FDA, medical societies, physician experience, medical literature, patient data changes over time, etc.

After the care provider prescribes medication and a treatment regimen or otherwise engages an icon for medicine or branded products on the prescription page, the system may show a video with educational material regarding the treatment regimen. The video may, if desired, be sent to the patient's secured area on a computing device for viewing at home. The system may also provide payment information and coupons or other information regarding discounts and insurance. The prescription is then sent to a clearing house pharmacy 15, FIG. 3.

The clearing house pharmacy 15 combines several things: 1) prescriptions; 2) information about the patient including insurance, contact information, favorite pharmacy and pharmacy benefits; 3) any discount programs that have been provided by a drug company for the prescription; 4) any foundations that exist that provide assistance to patients in need; 5) prior authorization forms that are required by insurance companies; etc.

The system and method of the preferred embodiments provide for administering a prescription and treatment regimen for a patient that goes beyond merely prescribing medication for a particular diagnosis. Based on patient data and other peripheral factors, a treatment regimen including the prescription medication can be identified to increase the effectiveness of the prescription medication and/or treatment regimen. The system provides a prescription platform that incorporates holistic treatment with prescription medications on one platform.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A method of administering a prescription and treatment regimen for a patient using a computer including a processor, a memory, a display, a network interface, and a user interface, the method comprising:
(a) inputting a diagnosis with the user interface;
(b) the processor accessing patient data either stored in the memory or stored remotely and accessible by the network interface;
(c) the processor accessing peripheral data relating to the diagnosis; and
(d) the processor identifying and displaying the treatment regimen for the diagnosis based on the patient data and the peripheral data by accessing a database either stored in the memory or stored remotely and accessible by the network interface, wherein the treatment is varied depending on the patient data and the peripheral data.

2. A method according to claim 1, wherein step (d) is practiced by organizing the treatment regimen into initial therapy, alternative therapy and ancillary therapy.

3. A method according to claim 1, wherein step (c) is practiced by accessing peripheral data including at least one of FDA guidelines, medical literature, physician experience, local trends and community data.

4. A method according to claim 1, wherein step (b) is practiced by accessing patient data including at least one of allergies, age, medical history, location of problem, race, distance from clinic, travel capabilities, family history, symptoms, vital signs, disease progression, and patient prior response to treatment.

5. A method according to claim 1, wherein step (d) is practiced by identifying and displaying the treatment regimen including the prescription and complementary procedures or actions to be performed by the patient.

6. A method according to claim 5, wherein step (d) is further practiced by displaying an educational video or identifying a link to the educational video.

7. A method according to claim 1, wherein step (d) is practiced by identifying and displaying phases of the treatment regimen including a first line phase, a second line phase, and a third line phase,
wherein the first line phase presents the treatment regimen based on cost and availability of the treatment to the patient, evidence based medical preferences, and low treatment risks,
wherein the second line phase presents the treatment regimen based on the patient data combined with patient response to the first line phase treatment if the first line phase treatment was ineffective, and
wherein the third line phase presents the treatment regimen based on the patient data combined with the patient response to the second line phase treatment if the second line phase treatment was ineffective, and higher risk and experimental treatments.

8. A method according to claim 1, wherein the peripheral data comprises a need for a referral to another provider, and wherein step (d) is practiced by identifying and displaying the treatment regimen including the referral to another provider.

9. A method according to claim 1, wherein step (d) is practiced by identifying and displaying a favorites treatment regimen specific to a user practitioner.

10. A method according to claim 1, wherein step (d) is practiced by dividing the display into three sections including a My Favorites section, a Branded Products section, and a System Average Treatments section,
wherein the My Favorites section lists commonly used treatment regimens for treating the diagnosis, the Branded Products sections lists one of branded products, available services, and paid advertisements, and the System Average Treatments section includes an average use of the treatment regimen for the diagnosis.

11. A method according to claim 10, further comprising enabling a user practitioner to move treatment regimens and components of treatment regimens into and out of the My Favorites section.

12. A method according to claim 10, further comprising, with the network interface, enabling a user practitioner to access a library of prescriptions, vitamins, herbs and procedures relevant to the diagnosis.

13. A method according to claim 1, wherein the treatment regimen comprises a prescription, the method further comprising (e) the processor sending the prescription to a clearing house pharmacy.

14. A non-transitory computer readable medium storing computer instructions that, when executed by computer, cause the computer to perform a method of administering a prescription and treatment regimen for a patient, the computer including a processor, a memory, a display, a network interface, and a user interface, the method comprising:
(a) inputting a diagnosis with the user interface;
(b) the processor accessing patient data either stored in the memory or stored remotely and accessible by the network interface;
(c) the processor accessing peripheral data relating to the diagnosis; and
(d) the processor identifying and displaying a treatment regimen for the diagnosis based on the patient data and the peripheral data by accessing a database either stored in the memory or stored remotely and accessible by the network interface, wherein the treatment is varied depending on the patient data and the peripheral data.

15. A system for administering a prescription and treatment regimen for a patient, the system comprising:
a computer including a processor, a memory, a display, a network interface, and a user interface, wherein the user interface is accessed to input a diagnosis;
a first database storing patient data, the processor being programmed to access the patient data through the memory or remotely by the network interface; and
a second database storing peripheral data relating to the diagnosis, the processor being programmed to access the peripheral data,
wherein the processor is programmed to identify and display the treatment regimen for the diagnosis based on the patient data and the peripheral data by accessing a third database either stored in the memory or stored remotely and accessible by the network interface, wherein the treatment is varied depending on the patient data and the peripheral data.
